(19) United States
(12) Patent Application Publication
(10) Pub. No.: US 2012/0282476 A1
(43) Pub. Date: Nov. 8, 2012

(54) Metallized Films Having Improved Adhesion, Articles Made Therefrom, and Method Making Same

(76) Inventors: Pang-Chia LU, Pittsford, NY (US); Rebecca A. LONG, Fresh Meadows, NY (US)

(21) Appl. No.: 13/423,554

(22) Filed: Mar. 19, 2012

Related U.S. Application Data
(60) Provisional application No. 61/482,420, filed on May 4, 2011.

(51) Int. Cl. B32B 15/08; B29C 47/06

(52) U.S. Cl. 428/461; 264/129

(57) ABSTRACT

Embodiments of the invention relate to a metallized, oriented multi-layer polymeric film having a) at least one layer A that includes a first polyolefin composition and b) a metallized layer B having a first side in surface contact with layer A, the metallized layer B includes (i) 50.0 to 99.9 wt % of a second polyolefin composition, and (ii) 0.1 to 50.0 wt % of at least one conductive polymer composition having a volume resistivity of 1.0×10⁵ to 1.0×10¹² ohm·cm (Ω·cm), based on the weight of the layer B. The film also includes a metal layer in surface contact with the metallized layer B. The films may be used as articles, particularly as flexible packaging and labels. Methods for making such films and articles are also described.

### PRIORITY CLAIM

This application claims the benefit and priority to U.S. Ser. No. 61/482,420, filed May 4, 2011 which is referenced in its entirety.

### FIELD OF THE INVENTION

The invention relates to films having improved metal adhesion. More particularly, the invention relates to films comprising a conductive polymer composition in a layer in surface contact with a metal layer.

### BACKGROUND OF THE INVENTION

In the packaging of certain types of foods including potato chips, snack foods, and the like, there is a high demand for packaging with high gas barrier and high water vapor barrier characteristics and also high durability. Multi-layer polymeric films, particularly polypropylene films, are commonly employed in such packaging applications due to their superior physical properties such as stiffness, and moisture barrier characteristics. Despite these desirable properties, unmodified polypropylene films often lack sufficient gas barrier properties needed for many applications.

Metallic films, such as aluminum foil, are well known in the art for packaging applications. Such metallic films may have both desirable gas barrier and moisture barrier properties, but typically are high in cost. Further, metallic films may lack the mechanical properties needed for many packaging applications.

To improve both gas barrier and moisture barrier properties, multi-layer films have been developed that offer the advantages of both polymeric films and metallic films. Such multi-layer films may typically comprise a polymeric core layer in combination with one or more other polymeric layers and/or metallized layers. For example, metallized, high barrier films may typically have a polypropylene core layer, a metallized layer and a sealant layer. Most commonly, the metallized layer comprises an ethylene-propylene (EP) or propylene-butylene (PB) polymer which is metallized on one surface thereof by vacuum deposition of a metal (e.g., aluminum), or another metallization process. Metal adhesion to EP and PB polymers, however, is typically too low for many packaging applications.

Multi-layer films comprising high density polyethylene in the metallized layer provide good metal adhesion, but exhibit weak gas barrier properties. Low density polyethylene (LDPE) resins, including linear low density polyethylene (LLDPE) resins, have been used with cyclic olefin polymers to promote improved inter-layer adhesion in the film structure.

But while cyclic olefin polymers provide improved metal adhesion to the polyethylene film surface layers, the compatibility of cyclic olefin polymers with polypropylene is limited. Thus, their use in polypropylene-containing metallizable layers is likewise limited.

Some metallized multi-layer films are laminated to other substrates, including various types of films, to protect the metallized surface. However, metal adhesion between the metallized surface and the laminated layer may be weak, resulting in low bond strength. Low bond strength may cause failure of the packaging structure, including peeling, at the interface between the metallized surface and the polymer(s) of laminated layer. Metal layer adhesion of a laminated film is critical to maintaining the structural integrity of the film as well as protecting the metallized surface from damage by the mechanical forces during package processing.

Thus, there remains a need for metallized films having a desirable balance of properties including metal adhesion, particularly to an underlying coextruded film layer or to a layer laminated thereto. Preferably, metallized films also have a low coefficient of friction to aid the film's processability.

### SUMMARY OF EMBODIMENTS OF THE INVENTION

In one aspect, the invention provides metallized, oriented multi-layer polymeric film comprising: a) at least one layer A, comprising a first polyolefin composition; b) a metallized layer B having a first side in surface contact with layer A, the metallized layer B comprising (i) 50.0 to 99.9 wt % of a second polyolefin composition, and (ii) 0.1 to 50.0 wt % of at least one conductive polymer composition having a volume resistivity of 1.0×10⁵ to 1.0×10¹² ohm·cm (Ω·cm), based on the weight of the layer B; and c) a metal layer in surface contact with the metallized layer B.

In particular embodiments of the metallized, oriented multi-layer polymeric film, the conductive polymer composition comprises a block polymer comprising blocks of a polyolefin and blocks of a hydrophilic polymer. Some suitable conductive polymer compositions have a number average molecular weight of 2.0×10³ g/mol to 6.0×10⁴ g/mol (determined by gel permeation chromatography). In particular embodiments, the conductive polymer composition comprises at least one polyether-polyolefin block copolymer. Another conductive polymer composition comprises at least one polyetherester-amide block copolymer.

In some embodiments, the invention provides a multi-layer polymeric film comprising: a) a barrier layer comprising aluminum, gold, silver, chromium, tin, copper or combinations thereof, preferably the barrier layer comprising aluminum; b) a layer B in surface contact with the barrier layer, comprising 50.0 to 99.9 wt % of a propylene-ethylene copolymer having from 75 to 99 wt % units derived from propylene and 5 to 25 wt % units derived from ethylene and 0.1 to 50.0 wt % of at least one polyether-polyolefin block copolymer, based on the weight of the layer B; c) a first tie layer in surface contact with the layer B, the first tie layer comprising a polypropylene homopolymer or a propylene-ethylene copolymer; d) a cavitated core layer in surface contact with the first tie layer, the core layer comprising polypropylene and 2.0 to 10.0 wt % of a cavitating agent; e) a second tie layer in surface contact with the cavitated core layer, the second tie layer comprising a polypropylene homopolymer or a propylene-ethylene copolymer; and f) a backside layer comprising a propylene-ethylene copolymer, a propylene-butylene copolymer or an ethylene-propylene-butylene terpolymer, wherein the backside layer is in surface contact with the second tie layer.

Embodiments of the metallized, oriented multi-layer polymeric films described herein may have improved properties such as surface resistivity and/or metal adhesion. For example, some films may have a surface resistivity of 1.0×10¹⁰ to 1.0×10¹⁴ ohm/sq and a metal adhesion strength of 155 to 240 g/cm.

In another aspect, embodiments of the invention provide a method of making metallized, oriented multi-layer polymeric film. Embodiments of the method include a) forming i) a layer A comprising a first polyolefin composition, and ii) a layer B comprising 50.0 to 99.9 wt % of a second polyolefin composition and 0.1 to 50.0 wt % of at least one conductive polymer composition, based on the weight of the layer B, the layer B having a first side and a second side, where the first side of the layer B is in surface contact with layer A; and b) metallizing the second surface of layer B. In particular methods, forming layer A and layer B comprises coextruding layer A and the layer B.

### BRIEF DESCRIPTION OF FIGURES

FIG. 1 represents the structure of an exemplary polymeric multi-layer film of the invention.

### DETAILED DESCRIPTION

The invention provides metallized, oriented multi-layer polymeric films wherein the metallized layer (i.e., the layer having a metal formed thereon) includes a blend of a polyolefin and one or more conductive polymer compositions in a layer in surface contact with a metal. The presence of the conductive polymer composition has surprisingly been found to improve the adhesion of metals to the metallized layer. Without wishing to be bound by theory, the inventors surmise that the polar or hydrophilic portions of such conductive polymers provide attachment sites for the metal without deleteriously affecting the desirable properties provided by the polyolefin.

As used herein, the term “film” applies to fabricated articles, extruded or otherwise, having an overall thickness in the range of about 0.1 to 250 mil (2.5 to 6350 μm).

As used herein, the term “layer” is used to refer to each of the one or more compositions, which may be the same or different, that are secured to one another by any appropriate means such as by an inherent tendency of the materials to adhere to one another, or by inducing the compositions to adhere as by a heating, radioactive, chemical, or some other appropriate process. Layers are not limited to detectable, discrete compositions contacting one another such that a distinct boundary exists between the compositions. In some embodiments, the composition used to make one layer of a film will be different (i.e., the wt % of components, the properties of each component, and/or the identity of the components may differ) from the composition used to make an adjacent layer, when present. A layer includes a finished product having a continuum of compositions throughout its thickness. The films of the present invention are multi-layer, that is, comprise two or more layers. A layer may be laminated, by extrusion lamination or other means, to another layer. Films can be fabricated by any mode recognized in the industry, such as film blowing.

As used herein, the term “polymer” refers to the product of a polymerization reaction, and includes homopolymers, copolymers, terpolymers, etc. For the purposes of this invention and the claims thereto, when a polymer is referred to as comprising a monomer, the monomer present in the polymer is the polymerized form of the monomer, also referred to herein as “derived units”. The term “derived units” refers to the polymerized form of the monomer from which the polymer was derived. For example, polyethylene comprises ethylene derived units, and a terpolymer of propylene/ethylene/butene comprises propylene derived units, ethylene derived units, and butene derived units.

The term “conductive polymer” refers to a polymer which has a volume resistivity of 1.0×10⁵ to 1.0×10¹² ohm·cm (Ω·cm), determined from a test piece (100×100×2 mm) using a megaohmeter C (Advantest) at 23° C. and 50% relative humidity according to ASTM D257.

A “polyolefin” comprises polymer units derived from one or more olefins. Exemplary polyolefins include polyethylene, polypropylene, ethylene-propylene copolymers, ethylene-propylene-butene terpolymers, and the like. For the purposes of this invention and the claims thereto, when a polymer is referred to as “comprising an olefin,” the olefin present in the polymer is the polymerized form of the olefin. An “olefin,” alternatively referred to as “alkene,” is a linear, branched, or cyclic compound of carbon and hydrogen having at least one double bond. An “alpha-olefin” is an olefin having a double bond at the alpha (or 1-) position. A “linear alpha-olefin” or “LAO” is an olefin with a double bond at the alpha position and a linear hydrocarbon chain. A “polyalphaolefin” or “PAO” is a polymer having at least 100 mer units.

A “propylene-based” polymer refers to a polymer comprising greater than 50.0 wt % of propylene derived units.

For purposes of this invention and the claims thereto, the term “copolymer” means any polymer comprising two or more different monomers, where “different” means differing by at least one atom, such as the number of carbons. For example, ethylene is a different monomer from propylene, because ethylene has two carbon atoms while propylene has three carbon atoms. Accordingly, the term “copolymer” includes the copolymerization reaction product of propylene and an alpha-olefin (α-olefin), such as ethylene. The term “copolymer” is also inclusive of, for example, the copolymerization of a mixture of more than two monomers, such as terpolymers. A “terpolymer” is a polymer consisting of three monomers that are different from each other, for example, an ethylene-propylene-butene terpolymer.

### Films

Multi-layer polymeric films providing improved metal adhesion are disclosed herein. The films of the invention are useful as labels, preferably printable labels. Labels containing these films have applications such as for labeling containers, e.g., bottles or cans, for beverages or other liquid products such as lotions, beauty supplies, or cleaning solutions. The films of the invention may also be useful as printable bags.

To facilitate discussion of different film structures, the following notation is used herein. Each layer of a film is denoted “A” or “B”, where “A” indicates a film layer comprising at least one polyolefin, particularly a propylene-based polymer, as discussed below, and “B” indicates a film layer comprising a polyether-polyolefin block copolymer, as discussed below. Films may also include additional layers, such as a layer C, comprising material different from either layer A or layer B. For example, layer C may comprise a substrate, a coating, or another polymeric resin. Where a film has more than one layer, the layers may be the same or different. For example, where a film has more than one layer B, the layers B may be the same or different. Finally, the symbols for adjacent layers are separated by a slash (/). Using this notation, a three-layer film having an inner layer of a propylene-based polymer disposed between a layer comprising at least one polyether-polyolefin block copolymer, and a layer of adhesive would be denoted B/A/C. Similarly, a four-layer film having an composition of an outer coating layer (e.g., a metal layer), a layer comprising at least one polyether-polyolefin block copolymer, a inner layer of a propylene-based polymer, and a layer of adhesive may be denoted C/B/A/C. Unless otherwise indicated, the left-to-right or right-to-left order of layers does not matter; e.g., a C/A/B/C film is equivalent to a C/B/A/C film.

“Outer” and “inner,” as used herein in reference to layers, refer to the relative spatial disposition of the layers. For example, for a layer configuration such as C/B/A/B/C, layer A is “inner” with respect to layer B, and each layer B is an “outer” layer with respect to layer A. Typically, each layer B is spatially disposed outwards relative to a layer A. The words “outer” and “inner” may also refer to the spatial position of a surface layer, particularly where the film is a label designed to be adhered to an article. In such instances, an “inner” surface layer generally refers to the side of the film to be adhered to the article, while the “outer” surface layer refers to the skin layer opposite the “inner” layer (e.g., a print-receiving layer or coating).

The thickness of each layer of the film, and of the overall film is determined according to the desired properties of the film. In some instances, microlayer technology may be used to produce films with a large number of thinner layers. For example, microlayer technology may be used to obtain films having, for example, 24, 50, or 100 layers, in which the thickness of an individual layer is less than 1 μm. Individual layer thicknesses for these films may be less than 0.5 μm, less than 0.25 μm, or even less than 0.1 μm.

The metallized, oriented multi-layer polymeric films can have any number of layers in any ratio of thicknesses. In a preferred embodiment, a three layer film is produced having an outer skin layer, a middle core layer, and an inner skin layer in a ratio within a range of from 1/1/1 to 1/20/1 in one embodiment, and from 1/2/1 to 1/15/1 in another embodiment, and from 1/3/1 to 1/10/1 in yet another embodiment. Each layer can be any desirable thickness, and is within the range of from 1 to 100 μm in one embodiment, and from 2 to 80 μm in another embodiment, and from 2 to 60 μm in yet another embodiment, and from 3 to 40 μm in yet another embodiment, and from 4 to 15 μm in yet another embodiment. Given the variety of film structures as mentioned above (e.g., ABC, CABAC, etc.), the total film thickness can vary greatly. Typical films have an overall thickness of from about 10 to about 100 μm. Of course, a desirable thickness range of the layers and film can comprise any combination of an upper limit with any lower limit, as described herein.

The metallized films described herein have a surface resistivity, as defined by ASTM D 257. The surface resistivity is the surface resistance multiplied by that ratio of specimen surface dimensions (width of electrodes defining the current path divided by the distance between electrodes) which transforms the measured resistance to that obtained if the electrodes had formed the opposite sides of a square. Surface resistivity is sometimes expressed in ohms, but is also popularly expressed also as ohms/square (the size of the square is immaterial and is the reciprocal of surface conductivity). (See, ASTM D 257-07, 3.1.10 and 3.1.10.1.)

In embodiments herein, the multi-layer polymeric films comprise at least one layer A and at least one layer B, wherein layer B comprises a conductive polymer and has been metallized, as discussed herein.

In addition to Layer A and the metallized layer B comprising conductive polymer, the polymeric films of this invention may comprise any number of additional layers C to achieve different objectives, such as adhesion to articles, abrasion resistance, curl control, moisture barrier, conveyance, etc.

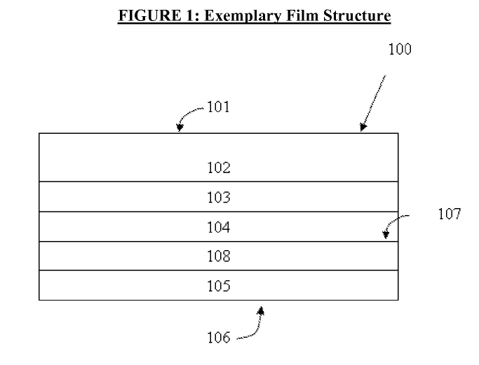

FIG. 1 shows an exemplary film structure 100, used herein to discuss the various components. Film structure 100 comprises five layers: a metal barrier layer 102, a layer A 103, a layer B 104, a primer coating 108, and an adhesive coating 105. Film structure 100 also has a metallized side 101 and an adhesive side 106.

The first side of layer B typically has the metal barrier layer 102 formed thereon. Metal barrier layer 102 may comprise any suitable barrier metal (e.g., aluminum, gold, silver, chromium, tin, copper), or mixtures thereof. Optionally the barrier layer 102 may have any number of other layers, primers, and/or coatings formed there over, particularly print coatings to render the film printable. As used herein, the term “printable” means having suitable properties to permit good quality printed results, such as uniformity of printed color, uniformity of ink transfer, good quality of black-and-white image, and consistency of ink drying and setting (See, Encyclopedia of Labels and Label Technology, M. Fairley, Taurus Publishing Ltd.). A printable layer may be applied by any conventional extrusion or coating method. Certain water-based coatings are known for their utility as printable coatings, for example, acrylic-based coatings including alkyl acrylate polymers and copolymers.

Layer B 103 may also be treated, prior to coating, so as to enhance metal adhesion. Surface treatment of any kind may be used to enhance the surface tension properties, e.g., flame, plasma, or corona treatment, as discussed below.

With respect to FIG. 1, the second side of layer B 103 is in surface contact with the first side of layer A 104. The layer A 104 may comprise one layer, or alternatively may comprise more than one layer. In embodiments herein, layer A 104 may comprise two, three, four, five, six, seven, eight, or more layers. In preferred embodiments, layer A 104 is a multi-layer film structure. In particularly preferred embodiments, layer A 104 consists of five layers. In some embodiments, the one or more outer surfaces of layer A 104 may be treated so as to enhance the surface tension properties, such as flame or corona treatment. For example, in certain embodiments, the second side 107 of layer A 104 is corona treated to improve adhesion of the primer 108. Thus, with respect to FIG. 1, the second side of layer A 104 may be coated by a primer 108. The second side of the primer 108 may be, in turn, coated by an adhesive coating 105.

The layers A and B, metal barrier layer, and the conductive polymer composition, and their respective components are described further below.

### Layer A

The films of the invention comprise at least one layer A. Layer A may comprise one layer, or alternatively may comprise more than one layer. In embodiments herein, layer A may comprise two, three, four, five, six, seven, eight, or more layers. In preferred embodiments, layer A is a multi-layer structure including one or more tie layers as described below.

Layer A has a first side and a second side. In embodiments herein, each layer A comprises a first polyolefin composition. Preferably, the first polyolefin composition of layer A comprises at least one propylene-based polymer having properties suitable for extrusion or coextrusion and biaxial orientation in the machine and transverse directions to form an oriented multi-layer film.

Propylene-based polymers useful herein include isotactic, syndiotactic, and atactic forms of propylene homopolymer, as well as propylene-based copolymers inclusive of random copolymers and terpolymers, and mixtures thereof useful in film applications. In addition to random polymers, statistical polymers and block copolymers, including blends thereof are useful. In particular, the propylene-based polymers useful herein include impact copolymers, elastomers, and plastomers, any of which may be physical blends or in situ blends with the polypropylene. Suitable polymers include at least one of a polypropylene, propylene-ethylene copolymer, propylene-butene copolymer, or propylene-ethylene-butylene terpolymer.

The method of making the polypropylene is not critical, as it can be made by slurry, solution, gas phase, or other suitable processes, and by using catalyst systems appropriate for the polymerization of polyolefins, such as Ziegler-Natta-type catalysts, metallocene-type catalysts, other appropriate catalyst systems, or combinations thereof. In a preferred embodiment the propylene-based polymers are made by the catalysts, activators and processes described in U.S. Pat. Nos. 5,741,563; 6,342,566; 6,384,142; WO 03/040201; and WO 97/19991. Likewise the copolymers may be prepared by the processes described in U.S. Pat. Nos. 6,342,566 and 6,384,142. Such catalysts are known in the art, and are described in, for example, ZIEGLER CATALYSTS (Gerhard Fink, Rolf Muelhaupt and Hans H. Brintzinger, Eds., Springer-Verlag 1995); Resconi et al., Selectivity in Propylene Polymerization with Metallocene Catalysts, 100, CHEM. REV., pp. 1253-1345 (2000); and I, II METALLOCENE-BASED POLYOLEFINS (Wiley & Sons 2000).

Preferred propylene-based polymers useful in this invention have one or more of the following properties: (i) a Mw of 30,000 to 2,000,000 g/mol, preferably 50,000 to 1,000,000 g/mol, or more preferably 90,000 to 500,000 g/mol, as measured by gel permeation chromatography (GPC); (ii) a Mw/Mn of 1 to 40, preferably 1.6 to 20, more preferably 1.8 to 10, or more preferably 1.8 to 3, as measured by GPC; (iii) a Tm (melting point, second melt) of 30 to 200° C., preferably 30 to 185° C., preferably 50 to 175° C., or more preferably 60 to 170° C., as measured by DSC; (iv) a crystallinity of 5 to 80%, preferably 10 to 70%, or more preferably 20 to 60%, as measured by DSC; (v) a glass transition temperature (Tg) of −40° C. to 20° C., preferably −20° C. to 10° C., or more preferably −10° C. to 5° C., as measured by differential scanning calorimetry (DSC); (vi) a heat of fusion (Hf) of 180 J/g or less, preferably 20 to 150 J/g, or more preferably 40 to 120 J/g as measured by DSC; and (vii) a crystallization temperature (Tc) of 15 to 120° C., preferably 20 to 115° C., or more preferably 25 to 110° C., as measured by DSC.

The propylene-based polymer may be a propylene homopolymer. In such embodiments, the propylene homopolymer has (i) a molecular weight distribution (Mw/Mn) of up to 40, preferably in the range of from 1.5 to 10, from 1.8 to 7, from 1.9 to 5, or from 2.0 to 4; and (ii) a melt-mass flow rate (MFR) in the range of from 0.1 g/10 min to 2500 g/10 min, from 0.3 to 500 g/10 min, or from 1 to 100 g/10 min, as measured by ASTM D1238, 230° C., 2.16 kg.

In some embodiments of the invention, the propylene-based polymer is a propylene copolymer, either random or block, of propylene derived units and at least one unit selected from ethylene and C₄ to C₂₀ alpha-olefin derived units, typically from ethylene and/or C₄ to C₁₀ alpha-olefin derived units, preferably butene, pentene, hexene, heptene, octene, nonene, decene, dodecene, 4-methyl-pentene-1,3-methyl pentene-1,3,5,5-trimethyl-hex-1-ene, and the like. In such embodiments, the propylene copolymer has at least one of the following properties: (i) an ethylene and/or C₄ to C₂₀ alpha-olefin derived unit content in the range of from about 0.1 wt % to 50.0 wt %, based on the weight of the copolymer, from 0.5 to 30 wt %, from 1 to 15.0 wt %, or from 0.1 to 5.0 wt %; (ii) a Mw of from greater than 8,000 g/mol, greater than 10,000 g/mol, greater than 12,000 g/mol, greater than 20,000 g/mol; (iii) a Mw/Mn in the range of from 1.5 to 10, from 1.6 to 7, from 1.7 to 5, or from 1.8 to 4; and (iii) a MFR in the range of from about from 0.1 g/10 min to 2500 g/10 min, or from 0.3 to 500 g/10 min, as measured by ASTM D1238, 230° C., 2.16 kg.

The procedure for measuring Tm is described as follows. Tm is measured using Differential Scanning calorimetry (DSC) using available equipment such as a TA Instruments 2920 DSC. Typically, 6 to 10 mg of molded polymer or plasticized polymer is sealed in an aluminum pan and loaded into the instrument at room temperature. Melting data (first heat) is acquired by heating the sample to at least 30° C. above its melting temperature, typically 220° C. for polypropylene, at a heating rate of 10° C./min. The sample is held for at least 5 minutes at this temperature to destroy its thermal history. Crystallization data are acquired by cooling the sample from the melt to at least 50° C. below the crystallization temperature, typically −50° C. for polypropylene, at a cooling rate of 20° C./min. The sample is held at this temperature for at least 5 minutes, and finally heated at 10° C./min to acquire additional melting data (second heat). The endothermic melting transition (first and second heat) and exothermic crystallization transition are analyzed for onset of transition and peak temperature. The melting temperatures reported are the peak melting temperatures from the second heat unless otherwise specified. For polymers displaying multiple peaks, the melting point (or Tm) is defined to be the peak melting temperature (i.e., associated with the largest endothermic calorimetric response in that range of temperatures) from the DSC melting trace; likewise, the crystallization temperature (Tc) is defined to be the peak crystallization temperature (i.e., associated with the largest exothermic calorimetric response in that range of temperatures) from the DSC crystallization trace. Areas under the DSC curve are used to determine the heat of transition (Hf, upon melting or heat of crystallization, Hc, upon crystallization, if the Hf value from the melting is different from the Hf value obtained for the heat of crystallization, then the value from the melting (Tm) shall be used), which can be used to calculate the degree of crystallinity (also called the % crystallinity).

Techniques for determining the molecular weight (Mn, number average molecular weight, and Mw, weight average molecular weight) and molecular weight distribution (Mn/Mw) may be found in U.S. Pat. No. 4,540,753, which is incorporated by reference herein, and in Macromolecules 1988, 21, 3360, which is also incorporated by reference herein. Mw and Mn may be determined by size exclusion chromatography (SEC), e.g., 3D SEC, also referred to as GPC-3D. The Mw/Mn, also known as the molecular weight distribution, is the ratio of Mw to Mn.

Suitable polymers include at least one of a polypropylene, propylene-ethylene copolymer, propylene-butene copolymer, or propylene-ethylene-butylene terpolymer. Propylene-based polymers useful in layers A and B include those available from ExxonMobil Chemical Company (Houston, Tex.) under the trade designations ACHIEVE™, EXXTRAL™, EXXONMOBIL™ random copolymers, or VISTAMAXX™; those available from Ineos Olefins and Polymers USA (League City, Tex.) under the trade designation INEOS KS333; and those available from LyondellBasell Polymers (The Netherlands) under the trade designations ADSYL or CLYRELL. Polypropylene available from Borealis Polymers (Vienna, Austria) and sold under the trade designation of HE 125M may also be used, as disclosed in EP 1 837 884.

Layer A can include a core layer in some embodiments and may comprise a polypropylene homopolymer or mini-random copolymer. The first side of the core layer is adjacent to, though not necessarily directly in contact with, the layer B. Preferably, the core layer has a thickness of approximately 13 μm to 240 μm. Typically, however, the core layer is between about 13 μm to 90 μm, preferably from about 10 μm to 25 μm; more preferably from 15 μm to 20 μm, exclusive of optional tie layers discussed below.

The term “mini-random copolymer” as used herein refers to a propylene-based copolymer comprising ≦3.0, particularly ≦1.0 wt % α-olefin comonomer-derived units. In particular embodiments, the mini-random copolymer is a propylene-based polymer that comprises ≦3.0 wt %, particularly ≦1.0 wt %, ethylene-derived units. Polypropylene homopolymers and mini-random copolymers suitable for the core layer include isotactic polypropylene (“iPP”), high crystallinity polypropylene (“HCPP”), or syndiotactic polypropylene (“sPP”), and combinations thereof. The polymers may be produced by Ziegler-Natta catalyst, metallocene catalyst, or any other suitable means. Such propylene-based polymers will generally have a melting point of at least about 140° C., or at least 150° C. Melt flow ratios of the polypropylenes may be in the range of 0.5 to 8, or 1.5 to 5 g/10 min ASTM D-1238, 230° C., 2.16 kg. Examples of propylene polymers include, but are not limited to, Total 3371 (from Total Petrochemicals Company), or PP4712 (from ExxonMobil Chemical Company).

In one form, the polypropylene homopolymer or mini-random copolymer is a high crystallinity polymer. A high crystallinity polymer may be desirable to maintain tensile strength of the film, which can be reduced by the presence of other layers. For example, the high crystallinity polymer enables the multi-layer film to maintain a stiffer modulus despite the softer more flexible polymers contained optional tie layers and/or the heat sealable skin layer. An example of a suitable HCPP is Total Polypropylene 3270, available from Total Petrochemicals.

In a particular form, the core layer comprises a HCPP with an isotacticity expressed in mmmm pentads of at least 97%, more preferably of at least 97.5%, as measured by ¹³C-NMR.

The films of the invention may be clear or opaque. In one embodiment, the film is opaque and comprises a cavitating agent. The cavitating agent may include a group of organic and inorganic materials including, for example, polybutylene teraphthalate (“PBT”), polyethylene terephthalate (“PET”), poly(ethylene 2,6-napthalate) (“PEN”), polycarbonate, polycarbonate alloy, nylon, cross-linked polystyrene, syndiotactic polystyrene, acetal, acrylic resins, polyacrylate, poly (N-vinylcarbozole), polyvinylcyclohexane, polyvinyl chloride, polyacrylonitrile, cyclic olefinic polymer, aliphatic polyketone, poly(4-methyl-1-pentene), ethylene vinyl alcohol copolymers, polysulfones, cross-linked polystyrene, cross-linked silicone polymers, solid or hollow pre-formed glass or polymer spheres, metal beads or spheres, ceramic spheres, calcium carbonate, talc, chalk, or combinations thereof. One cavitating agent is a cyclic olefinic polymer selected from a cyclic olefin homopolymer (“COH”), a cyclic olefin copolymer (“COC”), and blends thereof. COC is a copolymer comprising two monomers; one monomer being a cyclic olefin, such as a C₄ to C₁₂ cyclic olefin or norbornene, and the second monomer being an aliphatic olefin, such as ethylene, propylene, and butylene. The COC copolymer can be random, block, grafted, or any possible structure, having at least one co-monomer in the chain backbone. In some embodiments herein, the cavitating agent is PBT.

The cavitating agent can be added to any layer of the film. In some embodiments herein, the cavitating agent is added to layer A or a layer forming part of layer A. Typically the central layer in the film, e.g., the core layer includes the cavitating agent. The amount of the cavitating agent to be incorporated may correspond to the desired degree of void formation upon stretching. The film may comprise a cavitating agent or a blend of the cavitating agents in an amount of about 0.5 to about 70%, about 1.0 to about 60.0%, about 3.0 to about 60.0%, about 5.0 to about 50.0%, about 5.0 to about 30.0%, about 5.0 to about 20.0%, or about 5.0 to about 15.0%, based on the total weight of the layer to which the cavitating agent is added.

The core layer may further comprise at least one additive such as an opacifying agent, a hydrocarbon resin, or combinations thereof. An opacifying or coloring agent may be used in the core layer, e.g., silica, carbon black, aluminum, titanium dioxide (TiO₂), talc, and combinations thereof.

The core layer may comprise anti-static agents or migratory slip agents, such as fatty amides.

In some embodiments, the layer A includes a first tie layer that forms the first side of the core layer and is in surface contact with the layer B. In some embodiments, the layer A includes a region that may be called a second tie layer. The second tie layer forms the second side/surface of layer A. Where a second skin layer is present, the second tie layer is in surface contact with the second skin layer. These tie layers may include homo-, co-, or terpolymers comprising polypropylene, polyethylene, polybutylene, or blends thereof and may have a thickness of at least about 0.75 μm. The first side of the first tie layer is adjacent to the second side of the first skin layer; and the first side of the core layer is adjacent to the second side of the first tie layer. The second side of the second tie layer is adjacent to the first side of the second skin layer; and the second side of the core layer is adjacent to the first side of the second tie layer. Tie layers, when present, may include the same or different additives as the core layer and may be voided in the same or different manner, or may not be voided.

Thus, independently of other regions of layer A, the tie layer regions may also include a conventional non-void-inducing filler or pigment such as titanium dioxide. Generally, from an economic viewpoint at least, it has not been considered to be of any particular advantage to use more than about 10 wt % of titanium dioxide.

The thickness of the first tie layer region is not critical and typically ranges from about 0.6 μm to about 8.0 μm, particularly 1.0 μm to 6.0 μm, or 2.0 μm to 4.0 μm. In general, the preferred thickness of the tie layer is based on the overall film thickness, the desired stiffness, and seal properties.

### Layer B

The multi-layer polymeric films of the invention comprise at least one layer B. Layer B has a first side and a second side. Layer B is in surface contact with layer A and comprises a second polyolefin composition. Suitable polyolefins are those described for layer A, particularly propylene based polymers. The second polyolefin composition is preferably different from the first polyolefin composition. The polyolefin-content of Layer B is about 50.0 wt % to about 99.9 wt %, preferably about 60.0 wt % to about 98.0 wt %, about 65.0 wt % to about 95.0 wt %, about 80.0 wt % to about 95.0 wt %, particularly about 90.0 wt % to about 80.0 wt %, based on the combined weights of conductive polymers and polyolefins in layer B. The amount of polyolefin in layer B includes any polyolefin included as a compatibilizer in the polyether-polyolefin block copolymer.

In addition to the second polyolefin composition, the metallized layer B comprises 0.1 wt % to 50.0 wt % of at least one conductive polymer composition, based on the combined weights of conductive polymers and polyolefins in layer B. In some embodiments, the lower limit on the amount of conductive polymer in the metallized layer B is 1.0 wt %, 2.0 wt %, 5.0 wt %, 7.5 wt %, 10.0 wt %, 12.0 wt %, 15.0 wt %, 18.0 wt %, 20.0 wt %, 25.0 wt %, 30.0 wt %, 35.0 wt %, 40.0 wt %, or 45.0 wt %. The upper limit on the amount of conductive polymer in embodiments of the invention may be 2.0 wt %, 5.0 wt %, 7.5 wt %, 10.0 wt %, 12.0 wt %, 15.0 wt %, 18.0 wt %, 20.0 wt %, 25.0 wt %, 30.0 wt %, 35.0 wt %, 40.0 wt %, 45.0 wt %, or 50.0 wt %. In particular embodiments, the layer B comprises 2.0 to 40.0 wt %, 5.0 to 35.0 wt %, 5.0 to 25.0 wt %, or 10.0 to 20.0 wt % of the conductive polymer composition.

### (i) Conductive Polymers

Conductive polymers are usually used to provide antistatic properties to polymer compositions; however, surprisingly, such polymers are useful in the inventive films for promoting adhesion deposited metal layers. “Adhesion promoting” as used herein, indicates that the films including a polymer exhibit a higher metal adhesion than a film of the same structure and composition but lacking conductive polymer in layer B.

Conductive polymers are preferably block polymers comprising a polyolefin and a hydrophilic polymer having a structure wherein blocks of a polyolefin (a) and blocks of a hydrophilic polymer (b) are bonded together alternately and repeatedly. Some such conductive polymers have a structure such that blocks of (a) and blocks of (b) are bonded together alternately and repeatedly via at least one bonding mode selected from the group consisting of ester bonding, amide bonding, ether bonding, urethane bonding, and imide bonding.

Particular blocks of polyolefin are formed by a polyolefin having carbonyl groups, preferably as a carboxyl group, at both polymer termini, having hydroxyls at both polymer termini, or a polyolefin having amino groups at both polymer termini. Other suitable polyolefins have a carbonyl group at one polymer terminus, having a hydroxyl at one polymer terminus, or having an amino group at one polymer terminus can be used.

Particular polyolefins and polyolefin blocks are obtainable by polymerization of one or a mixture of two or more of olefins containing 2 to 30 carbon atoms (preferably olefins containing 2 to 12 carbon atoms, in particular preferably propylene and/or ethylene) and low-molecular-weight polyolefins obtainable by thermal degradation of high-molecular-weight polyolefins (polyolefins obtainable by polymerization of olefins containing 2 to 30 carbon atoms, preferably 2 to 12 carbon atoms, in particular preferably polypropylene and/or polyethylene).

Particular conductive polymers are described in U.S. Pat. Nos. 6,552,131 and 5,886,098, the descriptions of which are incorporated herein by reference in their entirety.

### Conductive Polyether-Polyolefin Block Copolymers

In particular embodiments herein, the polyether-polyolefin block copolymers comprise: (i) at least 50 mol % polyether blocks, at least 60 mol % polyether blocks, or at least 70 mol % polyether blocks; (ii) a number average molecular weight (Mn) in the range of from about 2,000 to 200,000 g/mol, from 3,000 to 150,000 g/mol, from 5,000 to 125,000 g/mol, or from 5,000 to 60,000 g/mol, as determined by gel permeation chromatography (GPC); and (iii) a surface resistivity of 1.0×10⁵ to 1.0×10¹¹ ohms/square, as measured by ASTM D257.

In embodiments herein, the polyether-polyolefin block copolymer is a block polymer which has a structure such that blocks of a polyolefin and blocks of a hydrophilic polymer are bonded together alternately and repeatedly, as disclosed in EP 1 452 305. Preferably, the blocks of the hydrophilic polymer are polyether blocks. In preferred embodiments, the polyether-polyolefin block copolymers comprise at least 50 mol % polyether blocks, at least 60 mol % polyether blocks, or at least 70 mol % polyether blocks.

The polyether blocks can be formed from one or more alkylene oxides having 2 to 4 carbon atoms. The polyether blocks can comprise ethylene oxide, propylene oxide, or butylene oxide, or combinations thereof. In preferred embodiments, the polyether blocks may be modified, for example, to have diol groups available for reaction with a modified polyolefin block, preferably one hydroxyl group at each polyether terminus.

Typically, the polyolefin blocks are obtained by polymerization of one or a mixture of two or more olefins containing 2 to 30 carbon atoms, preferably containing 2 to 12 carbon atoms, preferably propylene and/or ethylene. Alternatively, low molecular weight polyolefins blocks can be obtained by thermal degradation of high molecular weight olefins. The Mn of the polyolefin block is preferably 800 to 20,000 g/mol. (See, EP 1 452 305.) The polyolefin block may be modified to have carbonyl groups at both polyolefin block termini.

A polyether-polyolefin block copolymer can be formed by the reaction of a mixture comprising a modified polyether and a modified polyolefin, such as described in EP 1 167 425. For example, one or more polyether reactants such as polyether diols can be reacted with polyolefin reactants (obtained by modifying the termini of the polyolefin with carbonyl-containing groups or the like) and a polycondensation polymerization reaction carried out, at a temperature in the range of from about 200° C. to about 250° C., under reduced pressure, and employing catalysts such as zirconium acetate.

In a particular embodiment, the polyether-polyolefin block copolymer is a block polymer having a structure such that the polyolefin block and the polyether block are bonded together alternately and repeatedly, such that the polymers have a repeating unit represented by the following formula (1).

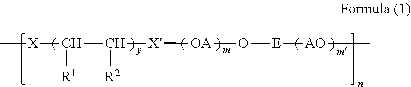

In Formula (1), n is an integer in the range of from 2 to 50; one of R¹ and R² is a hydrogen atom and the other is a hydrogen atom or an alkyl group containing 1 to 10 carbon atoms; y is an integer in the range of from 15 to 800; E is the residue of a diol after removal of the hydroxyl groups; A is an alkylene group containing 2 to 4 carbon atoms; m and m′ each represents an integer in the range of from 1 to 300; and X and X′ are connecting groups used in the synthesis of the block polymer as described in EP 1 167 425, hereby incorporated by reference.

In preferred embodiments, the polyether-polyolefin block copolymers comprise ethylene oxide polyether blocks. In such preferred embodiments, the polyether-polyolefin block copolymers comprise at least 50 mol % ethylene oxide (polyether blocks), at least 60 mol % ethylene oxide, or at least 70 mol % ethylene oxide.

In a particularly preferred embodiment, the polyether-polyolefin block copolymer comprises a block copolymer of polyethylene oxide polyether segments with polypropylene and/or polyethylene polyolefin segments. In one embodiment, the polyether-polyolefin block polymer has a Mn in the range of from about 2,000 to 200,000 g/mol, from 3,000 to 150,000 g/mol, from 5,000 to 125,000 g/mol, and from 5,000 to 60,000 g/mol, as determined by GPC. GPC techniques for determining the molecular weight (Mn and Mw, weight average molecular weight) and molecular weight distribution (Mn/Mw) may be found in U.S. Pat. No. 4,540,753, which is incorporated by reference herein, and in Macromolecules 1988, 21, 3360, which is also incorporated by reference herein.

A preferred polyether-polyolefin block copolymer is PELESTAT® 300, (Sanyo Chemical Industries, Ltd., Tokyo, Japan or Toyota Tsushu America Inc., Houston, Tex.), which is described in EP 1 167 425. Such a polyether-polyolefin block copolymer is a block polymer which has a structure such that blocks of a polyolefin and blocks of a hydrophilic polymer are bonded together alternately and repeatedly, and has a surface resistivity in the range of from about 1.0×10⁵ to 1.0×10¹¹ ohms/square, as measured by ASTM D257. Preferred polyether-polyolefin block copolymers include polyethylene oxide-polyethylene block copolymers, polyethylene oxide-polypropylene block copolymers, and the like.

Some polyether-polyolefin block copolymers such as PELESTAT® 300 do not require a compatibilizer, and, therefore, compatibilizers can be in some embodiments and be substantially absent from the conductive polymer composition. In such embodiments, the conductive polymer composition comprises polyether-polyolefin block copolymers in the range of 90 to 100 wt %, based on the total weight of the conductive polymer composition.

Any polyether-polyolefin block copolymer may be used in the conductive polymer compositions herein, preferably making the surface resistivity of the resultant film less than 1.0×10¹² ohms/square. Some examples of polyether-polyolefin block copolymers include IonPhasE® IPE® (IonomerPolyElectrolyte), from IonPhasE Oy; and PELESTAT®, from Toyota Tsushu America Inc., in particular PELESTAT® 300.

The polyether-polyolefin block copolymers useful herein have desirable electrical properties. Without wishing to be bound by theory, it is thought that ionic conduction along the polyether chains makes these polymers inherently dissipative, yielding surface resistivities in the range of from about 1.0×10⁶ to 1.0×10¹¹ ohms/square. (See, “Static dissipative compounds: solutions for static control,” Plastics Additives & Compounding, September 2001, Table 1.) Advantageously, these polymeric substances have dissipative properties, which are relatively independent of relative humidity (RH), unlike traditional migratory antistatic agents. Even more advantageously, polymeric substances containing a high concentration of polyether blocks may be melt-processed while retaining their antistatic property and overall physical performance. (See, WO 02/074534, page 6.)

### Conductive Polyetherester-Amides

Suitable conductive polyetheresteramide compositions are described in U.S. Pat. No. 5,886,098, incorporated herein in its entirety.

Conductive polymer compositions useful in particular embodiments of the invention include a polyetheresteramide comprising polymer units derived from (1) a polyamide oligomer having end units containing a carboxylic group and having a number average molecular weight from 200 to 5,000; and (2) a bisphenol compound containing oxyalkylene units, particularly 32 to 60 such units, and having a number average molecular weight from 300 to 3,000, preferably 1,600 to 3,000. The polyetheresteramide composition may also include 0.01% by weight based on the total composition of a halide of an alkali metal or an alkaline earth metal.

Compounds used to form the polyamide oligomers mentioned above are amino carboxylic acids, lactams, salts of diamines, and dicarboxylic acids. Examples of amino carboxylic acids are Ω-amino caproic acid, Ω-aminoenanthic acid, Ω-aminocaprylic acid, Ω-aminoperalgonic acid, Ω-aminocapric acid, 11-aminodecanoic acid, and 12-aminodecanoic acid. Examples of lactams are caprolactam, enantholactam, caprylolactam, and laurolactam. Diamines as the components of the salts mentioned above are hexamethylene diamine, heptamethylene diamine, octamethylene diamine, and decamethylene diamine; and dicarboxylic acids are adipic acid, azelaic acid, sebacic acid, undecane dicarboxylic acid, dodecane dicarboxylic acid, and isophthalic acid. Preferably, among these compounds are caprolactam, 12-aminododecanoic acid, salt of adipic acid, and hexamethylene diamine.

Polyamide oligomers with carboxylic chain ends having a number average molecular weight from 200 to 5,000 are obtained by the ring opening polymerization or polycondensation of the polyamide forming components in the presence of a molecular weight modifier. As molecular weight modifier dicarboxylic acids with from 4 to 20 carbons are usually used, more specifically aliphatic dicarboxylic acids, such as succinic acid, glutaric acid, adipic acid, pimelic acid, suberic acid, azelaic acid, sebacic acid, undecane dicarboxylic acid, and dodecane dicarboxylic acid; aromatic dicarboxylic acids, such as terephthalic acid, isophthalic acid, phthalic acid, naphthalene dicarboxylic acid, and 3-sulfoisophthalic acid alkali metal salt; and alicyclic dicarboxylic acids, such as 1,4-cyclohexane dicarboxylic acid, and dicyclohexyl-4,4′-dicarboxylic acid. Halogeno or sulfoxyl derivatives of these carboxylic acids are also used. Preferably, among these compounds are aliphatic dicarboxylic acids and aromatic dicarboxylic acids, more preferably are adipic acid, sebacic acid, terephthalic acid, isophthalic acid, and 3-sulfoisophthalic acid alkali metal salt.

Bisphenol compounds, another component of the polyetheresteramide of the invention, are shown by the following formula (2)

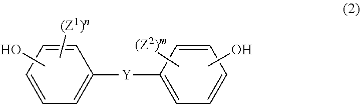

wherein Z¹ and Z² are groups selected from alkyl groups with from 1 to 4 carbons, aralkyl groups with from 6 to 10 carbons, aryl groups and halogen atoms, and Z¹ and Z² may be the same or the different groups. Y is a covalent bond, an alkylidene group, an aryl alkylidene group, an oxygen atom, a sulfur atom, a sulfonyl group, a bistrifluoromethyl methylene group or a carbonyl group, n and m being integers from 0 to 4.

Examples of the bisphenol compounds are dihydroxydiphenyl, C-alkyl substituted bisphenol; halogenated bisphenol; alkylene bisphenols such as bisphenol F; alkylidene bisphenols such as bisphenol A, cyclohexylidene bisphenol and bistrifluoromethyl methylene bisphenol; aryl alkylidene bisptienol; bisphenol S and hydroxybenzophenone. Preferably, along these compounds are alkylidene bisphenols, bisphenol A being more preferable.

The oxyalkylene units which are included in the bisphenol compounds are oxyethylene unit, oxypropylene unit, 1- or 2-oxybutylene unit and oxytetramethylene unit. Preferably, among these oxyalkylene units are oxyethylene units or the combination of oxyethylene and oxypropylene units.

The bisphenol compounds containing oxyalkylene units, namely oxyalkylated bisphenol compounds, which are used for the polyetheresteramide of the invention, should have a number average molecular weight ranging from 300 to 3,000, preferably from 1,600 to 3,000. It is particularly preferable to use the bisphenol compounds containing from 32 to 60 oxyethylene units. Using the bisphenol compound having a number average molecular weight smaller than 300 causes an unsatisfactory antistatic property of the polyetheresteramide, while using the bisphenol compound having a molecular weight larger than 3,000 brings about no or little increased improvement in antistatic property, but rather a disadvantage of requiring a prolonged time of manufacturing the polyetheresteramide.

The polyetheresteramide of the invention is obtained by the polycondensation of the above described polyamide oligomer and bisphenol compound in the presence of a known catalyst, such as antimony trioxide, monobutyl tin oxide, tetrabutyl titanate, tetrabutyl zirconate, and zinc acetate, according to need. It is preferable that the bisphenol chains with oxyalkylene units be contained in the amount of from 20 to 80% by weight of the polyetheresteramide. A content of the bisphenol chains less than 20% by weight causes an unsatisfactory antistatic property, while a content more than 80% by weight causes a decrease in heat resistance. The relative viscosity of the polyetheresteramide is preferably in the range from 0.5 to 4.0, more preferably from 0.6 to 3.0, measured as a 0.5% by weight solution of the polyetheresteramide in m-cresol at 25°.

### (ii) Compatibilizer

The conductive polymer compositions may optionally include a compatibilizer, such as a propylene-based polymer. In other words, the conductive polymer may, although need not be, provided to the layer (e.g., layer B 103) as a masterbatch, or blend, of the conductive polymer and another polymer composition (i.e., a compatibilizer).

In embodiments of the films herein, the conductive polymer composition is provided as a blend of: (i) 5.0 to 100 wt % of at least one polyether-polyolefin block copolymer, preferably 10 to 90 wt %, preferably 25.0 to 80 wt %, or preferably 5.0 to 50.0 wt %; and (ii) 0 to 95.0 wt % of at least one compatibilizer (e.g., a propylene-based polymer), preferably 10.0 to 90.0 wt %, from about 20.0 to about 75.0 wt %, or from 50.0 to 95.0 wt %; based on the combined weights of (i) and (ii); and (iii) optionally, at least one antioxidant.

In embodiments herein, the conductive polymer composition comprises from about 50 to 95.0 wt % of at least one propylene-based polymer, based on the combined weights of the propylene-based polymer and the polyether-polyolefin block copolymer. In other embodiments, the conductive polymer composition comprises from about 65.0 to 95.0 wt % of the propylene-based polymer, or from about 75.0 to about 95.0 wt % of the propylene-based polymer, based on the combined weights of the propylene-based polymer and the polyether-polyolefin block copolymer.

The propylene-based polymer has greater than 50 mol % propylene, greater than 60 mol % propylene, greater than 70 mol % propylene, greater than 80 mol % propylene, or greater than 90 mol % propylene. In some embodiments, the propylene-based polymer is a propylene homopolymer.

Some polyether-polyolefin block copolymers may require a compatibilizer to obtain the necessary miscibility with polyolefins, as will be understood by one of ordinary skill in the art. Also, conductive polymers, such as the polyether-polyolefin block copolymer described above, typically have less than robust mechanical properties and may not be feasible on their own as packaging materials. However, when alloyed with traditional packaging polymers, the result is a system that combines the desirable mechanical properties of the host polymer with the electrical properties of the conductive polymer. This alloying approach provides a polymer that can be injection molded, extruded, or thermoformed without deteriorating either the electrical or the mechanical properties. Moreover, these alloys can be designed to be clear and colorable, unlike traditional filler-based conductive compounds. Additionally, using conductive polymers instead of more traditional filler-based conductive compounds, particularly carbon black compounds, introduces no particulate contaminants to the polymer and typically contains only trace amounts of anions, cations, or offgassing materials. (See, “Static dissipative compounds: solutions for static control,” Plastics Additives & Compounding, September 2001, pages 16-19.)

Compatibilizers may be low molecular weight polymers with functional groups that are compatible with both the polyether-polyolefin block copolymers and the polymer in which it is being blended into for the final use, which may be otherwise immiscible or non-compatible. For example, compatibilizers useful herein may have functional groups that are compatible both with the conductive polymer (e.g., polyether-polyolefin block copolymer) and the polymers of layer A. Accordingly, the compatibilizer allows the polyether-polyolefin block copolymers and the blending polymer to be uniformly dispersed.

Any compatibilizer which can ensure compatibility between the polyether-polyolefin block copolymer and the blending polymer (polymers of layer A) by way of controlling phase separation and polymer domain size may be employed, such as those described in U.S. Pat. No. 6,436,619; EP A 0 342 066; and EP A 0 218 665. Some examples of compatibilizers are: polyethylene, polypropylene, ethylene/propylene copolymers, ethylene/butene copolymers, all these products being grafted with maleic anhydride or glycidyl methacrylate; ethylene/alkyl (meth)acrylate/maleic anhydride copolymers, the maleic anhydride being grafted or copolymerized; ethylene/vinyl acetate/maleic anhydride copolymers, the maleic anhydride being grafted or copolymerized; the two above copolymers in which anhydride is replaced fully or partly by glycidyl methacrylate; ethylene/(meth)acrylic acid copolymers and optionally their salts; ethylene/alkyl (meth)acrylate/glycidyl methacrylate copolymers, the glycidyl methacrylate being grafted or copolymerized, grafted copolymers constituted by at least one mono-amino oligomer of polyamide and of an alpha-mono-olefin (co)polymer grafted with a monomer able to react with the amino functions of said oligomer.

Some preferred compatibilizers are terpolymers of ethylene/methyl acrylate/glycidyl methacrylate and copolymers of ethylene/glycidyl methacrylate, such as LOTADER from Arkema Inc. (Houston, Tex.), or similar products. Preferred compatibilizers also include maleic anhydride grafted or copolymerized polyolefins, such as polypropylene, polyethylene, etc., such as OREVAC from Arkema Inc., or similar products.

(iii) Antioxidant

The conductive polymer composition and/or the polyolefins used in layers A and B may further comprise at least one antioxidant. Where present, the at least one antioxidant is in the range of about 0.05 to about 2.0 wt %, based on the weight of polymers in the particular layer, preferably from about 0.5 to about 1.5 wt %, or from about 0.75 to about 1 wt %. In some embodiments, more than one antioxidant may be used, two or more, or three or more.

Any antioxidant suitable for use in films may be used herein. Particularly useful antioxidants include, for example, hindered phenols such as 2,6-di-tert-butyl-4-methylphenol; 1,3,5-trimethyl-2,4,6-tris(3′,5′-di-t-butyl-4′-hydroxybenzyl)-benzerie; tetrakis[(methylene (3,5-di-t-butyl-4-hydroxyhydrocinnamate)]methane (IRGANOX™ 1010, Ciba Geigy, New York); tris(2,4-ditert-butylphenyl)phosphite (IRGANOX™ 168, Ciba Geigy); octadecyl-3,5-di-t-butyl-4-hydroxy cinnamate (IRGANOX™ 1076, Ciba Geigy); tert-butylhydroquinone (TBHQ); propyl gallate (PG); butylated hydroxyanisole (BHA); and butylated hydroxytoluene (BHT). Other antioxidants useful herein are described in U.S. Pat. Nos. 5,143,968 and 5,656,698, incorporated herein by reference.

In particular embodiments, the antioxidant comprises IRGANOX 1010. In particularly preferred embodiments, the antioxidant comprises both IRGANOX 1010 and IRGANOX 168, preferably in equal parts, as disclosed in EP 1 837 884.

In other embodiments, the conductive polymer is provided as a blend and comprises (i) 5.0 to 50.0 wt % of at least one polyether-polyolefin block copolymer, based on the combined weights of (i) and (ii); and (ii) 50 to 95.0 wt % of at least one propylene-based polymer, based on the combined weights of (i) and (ii). In some embodiments, the conductive polymer composition further comprises at least one antioxidant.

Some conductive polymers provided as a blend and useful herein include those available from Premix Oy (Rajamaki, Finland) under the tradename PRE-ELEC®, for example, PRE-ELEC® ESD 5050, PRE-ELEC® ESD 5060, and PRE-ELEC® TP 11515.

Alternatively, the conductive polymer may comprise any combination of the polyether-polyolefin block copolymers, polyetherester-amides, and propylene-based copolymers disclosed herein. Each of the components of the conductive polymer composition, namely the conductive polymer, the compatibilizer (propylene-based polymer), and the optional antioxidant, is discussed further below.

Conductive polymer compositions useful herein typically have a melt flow rate in the range of from about 0.5 to about 100 g/10 min, from about 2 to about 75 g/10 min, or from about 5 to about 50 g/10 min, as measured by ASTM D-1238, 230° C., 2.16 kg.

In embodiments herein, the conductive polymer compositions comprises: (i) 5.0 to 100 wt % of at least one polyether-polyolefin block copolymer based on the weight of the polymers in the conductive polymer composition, preferably 10 to 90 wt %, preferably 25.0 to 80 wt %, or preferably 5.0 to 50.0 wt %; and, optionally, (ii) 50 to 95.0 wt % of at least one propylene-based polymer; based on the combined weights of (i) and (ii); and, optionally, (iii) at least one antioxidant.

### Compounding

When compatibilizers, such as the propylene-based polymer described above, are blended with conductive polymers under certain compounding conditions, the formation of an interpenetrating network (IPN) structure has been reported. (See, “Static dissipative compounds: solutions for static control,” Plastics Additives & Compounding, September 2001, pages 16-19.) The IPN structure is reported to provide a polymeric, self-organizing, three dimensional interpenetrated network which is thought to allow charges to flow through the entire volume instead of only at the surface. Advantageously, the chance of creating hot spots is substantially reduced.

The components of the conductive polymer composition agent may be compounded, preferably to form an IPN structure, before incorporation of the conductive polymer composition into layer B. The formation of the IPN can be achieved by not overworking or overheating the components. (See, “Static dissipative compounds: solutions for static control,” Plastics Additives & Compounding, September 2001, page 18.)

In some embodiments herein, the conductive polymer composition may be compounded by first mixing the propylene-based polymer, the conductive polymer (e.g., polyether-polyolefin block copolymer) into one another in a rapid mixer such that a highly flowable pulver is achieved. Next, the other components, such as the antioxidant(s), may be mixed with the pulver and the mixture may be compounded, such as in a Berstorf ZE 40 twin-screw extruder. The turning of the screw of the extruder and the mixing conditions preferably enables a high shear rate in the range of from about 500 to about 5000 s⁻¹ to be achieved. The formation of an IPN is more likely with a high shear rate, as disclosed in EP 1 837 884.

### Coatings

In embodiments herein, the film is coated with one or more layers, which may the same or different, by the application of coating liquids. In particular, the adhesive or backside of layer A may be coated. In addition, metal formed over layer B may also be coated. The coating liquids may include any of adhesives, surfactants, binding agents, curing agents, pigments, optical brighteners, defoamers, cross-linking agents, rheological additives, and softeners. The coating liquids may be applied to the film surface by any means known in the art. The coating liquids may be applied to the film surface in any order known in the art to achieve the desired properties of the coated film, such as printability or adhesion.

In embodiments herein, the coating is printable. The printable coating may be any composition known in the art to be useful in retaining ink, dye, pigment, colorant, and the like. In other embodiments, the printable coating is printed, thereby retaining ink, dye, pigment, or colorant, and the like. In other embodiments, the coating is a primer. In yet other embodiments, the coating is an adhesive primer.

Surfactants useful herein have a reducing effect on the dynamic surface tension of an aqueous system. In conventional coating processes, ionic and/or non-ionic surfactants are used. Non-ionic surfactants are, for example, glycols, polyglycols, or polyoxyalkylene glycols, such as, for example, C₁₁-oxo-alcohol polyglycol ether sold under the tradename GENAPOL UD050 (Clariant Technologies, Muttenz, Switzerland); ethoxylated and non-ethoxylated 2,4,7,9-tetramethyl-5-decyl-4,7-diols; oxiranes such as 2-methoxymethyloxirane, sold under the tradename DENACOL EX-821 (Shanghai Licheng Chemical Co., Shanghai, China), 1,4-dimethyl-1,4-bis(2-methyl-propyl)-2-butyl-1,4-diethylether; 1,3-pentanediol, trimethylpentanediol; glycerine, t-octylphenoxypolyethoxyethanol sold under the tradename TRITON X100 (Dow Chemical, Freeport, Tex.), and terstol. Ionic surfactants are, for example, sodium salts of polyacrylic acids, quaternary alkyl ammonium salts (e.g., hexadecyltrimethylammonium chloride), betaines, or metal salts of fatty acids, aliphatic esters of dicarboxylic acids, and lauryl sulfates.

Pigments useful herein include chalk, kaolin, talcum; calcium carbonate such as precipitated calcium carbonate sold under the tradename MULTIFEX MM (Specialty Minerals, Inc., Bethlehem, Pa.), mica, titanium dioxide, ammonium zirconium carbonate such as sold under the tradename AZCOTE 5800M (Hopton Technologies Inc., Albany, Oreg.), silicic acid (silica) such as colloidal dioxosilane sold under the tradename LUDOX AS40 (Alfa Aesar, Ward Hill, Mass.), or aluminum oxide.

It is also possible to use additional coating fluids comprising styrene-butadiene, styrene-acrylate, acrylic emulsions such as those available under the tradename NEOCRYL XY90 (Neoresins, the Netherlands), vinyl acetate, vinyl acetate copolymers, functionalized copolymer dispersions such as those available under the tradename MICHEM® PRIME 4983R (Michelman Inc., Cincinnati, Ohio), nanoscale wax emulsions such as those available under the tradename MICHEM® LUBE ML215 (Michelman Inc.), acetoacetoxyethylmethacrylate such as those available under the tradename AAEM from Eastman Chemicals, Kingsport, Tenn.), crosslinked polymethylmethacrylate resin such as that available under the tradename EPOSTAR MA-1004 (Nippon Shokubai Chemicals, Kawasaki, Japan), polyethylene/wax microsized zirconia such as those available under the tradename ME09730 from Michelman Inc., antiblocking agents such as those available under the tradename TOSPEARL T120 (GE Silicones, Wilton, Conn.), curing agents such as those available under the tradename IMICURE EMI-24 (Air Products and Chemicals Inc, Allentown, Pa.), ethylene-oxide/propylene oxide copolymer such as those commercially available under the tradename TERGITOL 15S9 (Dow Chemical Company, Freeport, Tex.), an adhesion-promoting tie layer such as PRIMACOR™ ethylene-acrylic acid copolymers available from Dow Chemical Company, and/or ethylene-vinyl acetate copolymers, or polyurethane.

### Layer C

In some embodiments, the multi-layer polymeric film may comprise an additional layer C, where layer C may comprise, for example, foil, nylon, ethylene-vinyl alcohol copolymers, polyvinylidene chloride, polyethylene terephthalate, oriented polypropylene, ethylene-vinyl acetate copolymers, ethylene-acrylic acid copolymers, ethylene-methacrylic acid copolymers, graft modified polymers, and paper. Further, one or more C layers can be replaced with a substrate layer, such as glass, plastic, paper, metal, etc., or the entire film can be coated or laminated onto a substrate. Thus, the inventive multi-layer polymeric films disclosed herein, can be coated onto a substrate such as paper, metal, glass, plastic and other materials capable of accepting a coating. Such coated structures and articles are also within the scope of the present invention.

### Additives

Any of the layers described herein may comprise one or more additives. The layer may comprise additives in the range of from about 0.1 to about 10 wt %, based on the total weight of the polymers comprising the layer. Preferred inorganic and organic additives include, for instance, other antistatic agents, ultraviolet light absorbers, plasticizers, pigments, dyes, antimicrobial agents, anti-blocking agents (such as anti-block MB), stabilizers, lubricants (e.g., slip agents, such as slip MB), processing aids, white pigments, such as titanium oxide, zinc oxide, talc, calcium carbonate, etc., matte beads, compatibilizers, dispersants, for example, fatty amides, such as stearamide, etc., hardeners, quaternary salts, metallic salts of fatty acids, such as zinc stearate, magnesium stearate, etc., pigments and dyes, such as ultramarine blue, cobalt violet, etc., and fluorescent whiteners. Preferred additives include white pigments such as the titanium dioxide masterbatch formulations available from Ampacet Corporation (Tarrytown, N.Y.), for example, under the trade designation AVK60.

### Film Formation

To make the multi-layer films disclosed herein, any process that is known in the art can be used, such as film-blowing, tenter processes, and casting. The multi-layer films may also be used in extrusion coating and thermoforming. In particular embodiments, the multi-layer films disclosed herein may be made by conventional fabrication techniques, for example, simple bubble extrusion, biaxial orientation processes (such as tenter frames or double bubble processes), cast/sheet extrusion, coextrusion, lamination, etc. Conventional simple bubble extrusion processes (also known as hot blown film processes) are described, for example, in The Encyclopedia of Chemical Technology, Kirk-Othmer, Third Edition, John Wiley & Sons, New York, 1981, Vol. 16, pp. 416-417 and Vol. 18, pp. 191-192, the disclosures of which are incorporated herein by reference. Biaxial orientation film manufacturing processes, such as described in the “double bubble” process of U.S. Pat. No. 3,456,044 (Pahlke), and the processes described in U.S. Pat. No. 4,352,849 (Mueller), U.S. Pat. Nos. 4,820,557 and 4,837,084 (both to Warren), U.S. Pat. No. 4,865,902 (Golike et al.), U.S. Pat. No. 4,927,708 (Herran et al.), U.S. Pat. No. 4,952,451 (Mueller), and U.S. Pat. Nos. 4,963,419 and 5,059,481 (both to Lustig et al.), the disclosures of which are incorporated herein by reference, can also be used to make the novel film structures of this invention.

Advantageously, the layers of the inventive films may be formed directly during the (co)-extrusion step of the film forming process, thus eliminating the need to coat and dry a solvent-based antistatic layer, as has been the practice before. Preferably, the film is co-extruded, cast, oriented, and then prepared for its intended use such as by coating, printing, slitting, or other converting methods.

Typically, the film is formed by coextruding the layers together through a flat sheet extruder die at a temperature between about 200° C. to about 275° C., casting the film onto a cooling drum and quenching the film. The sheet may then be stretched, i.e., oriented in any desirable fashion. The film may be stretched prior to metallization by a factor of 1.1 to about 6 times in the machine direction (MD). Where stretching in the transverse direction (TD) is desired, the film may be stretched by a factor of 1.1 to about 10 times its original width.

In some embodiments, one or more layer may be modified by corona treatment, electron beam irradiation, gamma irradiation, or microwave irradiation. In a preferred embodiment, one or both of the surface layers of a particular layer is modified by corona treatment, which includes exposing the film surface to a high voltage corona discharge while passing the film between a pair of spaced electrodes. In particular, corona treatment may produce a significant difference in the kinetic coefficient of friction of the two surface layers. The surface of the layer may be treated during or after orientation. After electronic treatment of the film surface, a coating may then be applied thereto.

The multi-layered film may also comprise additional coatings and/or layers capable of accepting another layer. For example, as used herein, an adhesive primer is a layer that is capable of accepting an adhesive coating. Other types of coatings that find utility in the multi-layer films of the present invention include printable or printed coatings, sealable coatings, and coatings that reduce the coefficient of friction.

The layer A (or layer) usually represents about 70.0 to about 90.0% of the thickness of the total multi-layer film. The skin layers are usually coextensively applied to each surface of the layer A, typically by coextrusion, as noted above. Consequently, the first or second layers may not, ultimately, be the outermost layers.

In some embodiments, the forming of layer B further comprises mixing: (a) at least one polyolefin; and (b) the polyether-polyolefin block copolymer; wherein the polyether polyolefin copolymer is provided as a blend of: (i) 5.0 to 50.0 wt % of at least one polyether-polyolefin block copolymer; (ii) 50.0 to 95.0 wt % of at least one propylene-based polymer, based on the combined weights of (i) and (ii); and (iii) optionally, an antioxidant.

In some embodiments, the method further comprises coating a side of the film with a primer and/or an adhesive.

Yet other embodiments relate to a method for making multi-layer polymeric films comprising: (a) forming a layer A, comprising one or more polyolefins, having a first side and a second side; (b) forming a layer B, comprising one or more polyolefins, having a first side and a second side; (c) forming a film comprising layer A and layer B wherein the first side of layer B is on the second side of layer A, preferably the layers are co-extruded to form the multi-layer polymeric film, preferably the film is oriented; (d) coating layer A with a coating; and (e) optionally, coating the second side of layer B, preferably the coating is an adhesive primer; wherein layer B comprises 0.01 to 50.0 wt % of a polyether-polyolefin block copolymer, based on the weight of the polymers comprising the layer, preferably about 5.0 wt % to about 40.0 wt %, or preferably about 5.0 wt % to about 35.0 wt %.

Even other embodiments relate to the method where the forming of layer B further comprises mixing: (a) at least one polyolefin; preferably propylene-based polymer; and (b) the polyether-polyolefin block copolymer; wherein the polyether-polyolefin copolymer comprises a blend of: (i) 5.0 to 50.0 wt % of at least one polyether-polyolefin block copolymer; (ii) 50 to 95.0 wt % of at least one propylene-based polymer, based on the combined weights of (i) and (ii); and (iii) optionally, at least one antioxidant, preferably two or more, or preferably three or more, and preferably the antioxidant comprises 0.05 to about 2 wt % of the blend, based on the weight of (i) and (ii), preferably from about 0.5 to about 1.5 wt %, or from about 0.75 to about 1 wt %.

Other embodiments herein, relate to a printable article comprising a multi-layer polymeric film having: (a) at least one layer A, comprising one or more polyolefins, having a first side and a second side; (b) a layer B, comprising one or more polyolefins, having a first side and a second side, where the first side of B is located on the second side of layer A; and (c) a printable coating located on the first side of layer B; wherein layer B comprises 0.01 to 50.0 wt % of at least one polyether-polyolefin block copolymer, based on the weight of the polymers comprising the layer.

Some embodiments herein, relate to the printable article, where the polyether-polyolefin block copolymer is provided as a blend of: (i) 5.0 to 50.0 wt % of at least one polyether-polyolefin block copolymer; (ii) 50.0 to 95.0 wt % of at least one propylene-based polymer, based on the combined weights of (i) and (ii); and (iii) optionally, an antioxidant. In such embodiments, the blend has a melt flow rate in the range of from about 0.5 to about 100.0 g/10 min, preferably in the range of from about 2 to about 75 g/10 min (ASTM D-1238, 203° C., 2.16 kg).

Some embodiments herein, relate to the printable article, where the printable coating is printed. Other embodiments relate to the printable article, wherein the article is a printed or printable label. Other embodiments relate to the use of the composition of the printable multi-layer polymeric film, or as made by the methods of making a printable multi-layer polymeric film, as a label or a bag; preferably as a printed label or a printed bag.

In other embodiments, the layer B may be considered a metallizable or metallized layer. Thus, in certain embodiments, the multi-layer polymeric film includes (a) at least one layer A, comprising one or more polyolefins, having a first side and a second side; (b) a layer B, comprising one or more polyolefins, having a first side and a second side, where the first side of B is located on the second side of layer A; and (c) a printable coating located on the first side of layer B; wherein layer B comprises 0.01 to 50.0 wt % of at least one polyether-polyolefin block copolymer, preferably about 5.0 wt % to about 40.0 wt %, about 5.0 wt % to about 35.0 wt %, about 5.0 wt % to about 20.0 wt %, or about 10.0 wt % to about 20.0 wt %, based on the weight of the polymers comprising the layer. In such embodiments, layer B also typically includes 0.01 to 50.0 wt % of at least one polyolefin, particularly a propylene-based polymer, such as isotactic polypropylene, propylene-ethylene copolymer comprising ≦1.5 wt % polymer units derived from ethylene (i.e., mini-random propylene-ethylene copolymer), higher ethylene content propylene-ethylene copolymers, propylene butane copolymers, ethylene-propylene-butene terpolymers, and mixtures thereof. Typically such, the total amount of propylene based polymers is about 60.0 wt % to about 95.0.0 wt %, about 65.0 wt % to about 95.0 wt %, about 80.0 wt % to about 95.0 wt %, or about 80.0 wt % to about 90.0 wt % based on the weight of the polymers comprising the layer B. Some embodiments further comprise a metal barrier layer on layer B.

Before applying the metal to the layer B, its surface may be treated to increase its surface energy. This treatment can be accomplished by employing known techniques, such as flame treatment, plasma treatment, polarized flame, corona discharge, and film chlorination, e.g., exposure of the film surface to gaseous chlorine, treatment with oxidizing agents, such as chromic acid, hot air or steam treatment, flame treatment, and the like. Although any of these techniques is effectively employed to pre-treat the film surface, a frequently preferred method is corona discharge, a treatment method that includes exposing the film surface to a high voltage corona discharge while passing the film between a pair of spaced electrodes. After treatment of the film surface, the metal is then applied thereto.

A dual treatment may also be employed to increase the surface energy of the outer surface of the film. In a dual treatment process, the outer surface of the film is treated by any of the methods discussed above immediately following orientation of the film. Subsequent to the first treatment, the film is subjected to plasma treatment just prior to metallization.

The metal barrier may be formed on the outer surface layer B using conventional methods, such as vacuum deposition of a metal layer such as aluminum, gold, silver, chromium, tin, copper, or mixtures thereof. Aluminum is particularly preferred.

### Film Properties and Test Methods

The films made from the compositions of the present invention have a new and useful combination of properties that allow them to be used as films for label applications with better metal or ink adhesion.

Films herein have one or more of the following optical, surface, and antistatic properties: (i) a gloss 45° of greater than 56, greater than 58, or greater than 60, as measured by ASTM D 2457; (ii) a light transmission of greater than 22%, greater than 25%, or greater than 35%, as measured by ASTM D 1003; (iii) a whiteness in the range of from about 70 to 90%, from about 75 to about 90%, or from about 85 to about 90%, as measured by ASTM E 313; (iv) a kinetic coefficient of friction for the layer A side of the film in the range of from about 0.30 to 0.70, from about 0.35 to about 0.65, or from about 0.35 to about 0.50, as measured by ASTM D1894; (v) a surface tension for the layer A side of the film greater about 31 mN/m, greater than 35 mN/m, or greater than 50 mN/m, as measured by ASTM D 2578; (vi) a 90% static decay of about 800 milliseconds or less, about 500 milliseconds or less, or about 350 milliseconds or less, measured using ASTM D 257; and (vii) a surface resistivity in the range of from about 1.0×10⁶ to about 1.0×10¹² ohms/square, from about 1.0×10⁸ to about 1.0×10¹² ohms/square, or from about 1.0×10¹⁰ to about 1.0×10¹² ohms/square, measured at 47% RH and 21.5° C., using ASTM D 257.

### Optical Properties

Good gloss, light transmission (LT), and whiteness are desirable optical properties in multi-layer polymer films, especially those used in label applications. Multi-layer films disclosed herein demonstrate comparative or improved optical properties, as compared to a reference film.

Gloss provides information about the shininess or gloss of the film. Gloss measurement involves specular reflection, which is a sharp light beam reflecting from the film surface, at a specific angle of incidence, herein 45°. Gloss usually varies as a function of surface smoothness and flatness. For the purposes of the claims herein, gloss 45° of the multi-layer polymeric films is determined as per ASTM D 2457. The inventive films have comparative gloss to the reference films as disclosed herein in Table 3. In embodiments herein, the inventive films have a gloss 45° of greater than 56, greater than 58, or greater than 60.

LT is the percentage of incident light that passes through a film. For the purposes of the claims herein, LT is determined as per ASTM D 1003, using a spectrophotometer. The inventive films have comparative LT to the reference films as disclosed in Table 3. In embodiments herein, the inventive films have a LT of greater than 22%, greater than 25%, or greater than 35%.

Whiteness is psychophysically estimated for the purposes of the claims herein, using procedures outlined in ASTM E 313. The inventive films have comparative whiteness to the reference films as disclosed in Table 3. In embodiments herein, the inventive films have a whiteness greater than 70%, greater than 75%, greater than 85%, or greater than 90%. In other embodiments, the whiteness is in the range of from about 70 to about 90%, from about 75 to about 90%, or from about 85 to about 90%.

### Surface Properties

Surface properties of the multi-layer polymeric films disclosed herein include surface tension and kinetic coefficient of friction.

Kinetic coefficient of friction is related to the slip properties of films, and is determined for the purposes of the claims herein, using ASTM D 1894, using a stationary sled with a moving plane at 23° C. The inventive films have comparative kinetic coefficient of friction to the reference film as disclosed in Table 3. In embodiments herein, the inventive films have a kinetic coefficient of friction for the layer A side of the film in the range of from about 0.30 to 0.65, from about 0.35 to about 0.65, or from about 0.35 to about 0.50.

Surface tension is an indicator of the wettability of the surface and its ability to accept and retain inks, coatings, adhesives, etc., and is measured for the purposes of the claims herein, by ASTM D 2578. The inventive films have greater surface tension as compared to the reference film, as disclosed in Table 3. In embodiments herein, the inventive films have a surface tension for the layer A side of the film greater about 31 mN/m, greater than 35 mN/m, or greater than 50 mN/m.

### Antistatic Properties

Antistatic properties of the multi-layer polymeric films disclosed herein include maximum charge after cycling, residual charge after 300 s decay time, 50% static decay time, 90% static decay time, and surface resistivity, which are measured for the purposes of the claims herein, using ASTM D 257, using a guard circuit equipped with a guard electrode.

The multi-layer polymeric films have an improved 90% static decay when compared to the reference film, as shown in Table 4. The inventive films have a 90% static decay of about 800 milliseconds or less, about 500 milliseconds or less, or about 350 milliseconds or less.

Surface resistivity is a measure of a sample's inherent resistance to a flow of electrical current and is measured by ASTM D 257. The inventive films have improved surface resistivity compared to the reference film, as disclosed in Table 4. The inventive films have a surface resistivity of less than 1.0×10¹² ohms/square, measured at 47% RH and 21.5° C., preferably in the range of from about 1.0×10⁶ to about 1.0×10¹² ohms/square, preferably in the range of about 1.0×10⁸ to about 1.0×10¹² ohms/square; or preferably in the range of 1.0×10⁸ to about 1.0×10¹⁰ ohms/square.

### PARTICULAR EMBODIMENTS

1. Embodiments of the invention provide a metallized, oriented multi-layer polymeric film comprising: a) at least one layer A, comprising a first polyolefin composition; and b) a metallized layer B having a first side in surface contact with layer A, the metallized layer B comprising (i) 50.0 to 99.9 wt % of a second polyolefin composition and (ii) 0.1 to 50.0 wt % of at least one conductive polymer composition having a volume resistivity of 1.0×10⁵ to 1.0×10¹² ohm·cm (Ω·cm), based on the weight of the layer B; and c) a metal layer in surface contact with the metallized layer B.
2. Embodiments of the metallized, oriented multi-layer polymeric film of embodiment 1 include films wherein the conductive polymer composition comprises a block polymer comprising blocks of a polyolefin and blocks of a hydrophilic polymer.
3. Embodiments 1 and 2 include films wherein the conductive polymer composition has a number average molecular weight of 2.0×10³ g/mol to 6.0×10⁴ g/mol as determined by gel permeation chromatography.
4. Embodiments 1 to 3 include films wherein the conductive polymer composition comprises at least one polyether-polyolefin block copolymer.
5. Embodiment 4 includes films wherein the conductive polymer composition comprises:
(i) 5.0 to 50.0 wt % of the at least one polyether-polyolefin block copolymer; and
(ii) 50 to 95.0 wt % of at least one propylene-based polymer; based on the combined weights of (i) and (ii).
   6. Embodiments 1 to 5 include films wherein the conductive polymer composition comprises at least one polyetherester-amide block copolymer.
   7. Embodiment 6 includes, wherein the conductive polymer composition comprises:
(i) 3.0 to 40.0 wt % of the at least one polyetherester-amide block copolymer; and
(ii) 60.0 to 97.0 wt % of at least one propylene-based polymer; based on the combined weights of (i) and (ii).
   8. Embodiments 1 to 7 include films wherein the layer B comprises from 5.0 to 25.0 wt % of the conductive polymer composition.
   9. Embodiments 1 to 8 include films wherein the layer B comprises from 10.0 to 20.0 wt % of the conductive polymer composition.
   10. Embodiments 1 to 9 include films wherein layer A comprises a tie layer and a core layer, wherein the tie layer is in surface contact with the layer B.
   11. Embodiments 1 to 10 include films wherein layer A includes a cavitating agent.
   12. Embodiments 1 to 11 include films wherein the first polyolefin composition and the second polyolefin composition are the same or different.
   13. Embodiments 1 to 12 include films wherein the first polyolefin composition has a comonomer content, a Mw, a MWD, a melt flow rate, or a melting point different from the comonomer content, Mw, MWD, melt flow rate, or melting point of the second polyolefin composition.
   14. Embodiments 1 to 13 include films wherein the first polyolefin composition comprises one or more polypropylene homopolymers and/or one or more copolymers of propylene and at least one C₂ or C₄-C₂₀ α-olefin.
   15. Embodiments 1 to 14 include films wherein the second polyolefin composition comprises one or more copolymers of propylene and at least one C₂ or C₄-C₂₀ α-olefin.
   16. Embodiments 1 to 15 include films wherein metallized layer comprises a conductive polymer composition having a surface resistivity ≦1.0×10¹⁵ ohms/square, measured at 50% RH and 23° C.
   17. Embodiments 1 to 16 include films having a metal adhesion strength ≧150 g/cm.
   18. Embodiments 1 to 17 include films wherein the metal layer comprises at least one metal selected from the group consisting of aluminum, gold, silver, chromium, tin, copper and combinations thereof.
   19. Embodiments of the invention include a multi-layer polymeric film comprising:
a) a barrier layer comprising aluminum, gold, silver, chromium, tin, copper or combinations thereof, preferably the barrier layer comprising aluminum;
b) a layer B in surface contact with the barrier layer, comprising 50.0 to 99.9 wt % of an propylene-ethylene copolymer having from 75 to 99 wt % units derived from propylene and 5 to 25 wt % units derived from ethylene and 0.1 to 50.0 wt % of at least one polyether-polyolefin block copolymer, based on the weight of the layer B;
c) a first tie layer in surface contact with the layer B, the first tie layer comprising a polypropylene homopolymer or a propylene-ethylene copolymer;
d) a cavitated core layer in surface contact with the first tie layer, the core layer comprising polypropylene and 2.0 to 10.0 wt % of a cavitating agent;
e) a second tie layer in surface contact with the cavitated core layer, the second tie layer comprising a polypropylene homopolymer or a propylene-ethylene copolymer; and
f) a backside layer comprising a propylene-ethylene copolymer, a propylene-butylene copolymer or an ethylene-propylene-butylene terpolymer, wherein the backside layer is in surface contact with the second tie layer.
   20. Embodiment 19 includes films having a metal adhesion strength of 400 to 600 g/in.
   21. Embodiments of the invention include labels comprising the films of Embodiments 1-20.
   22. Embodiments of the invention include a method of making metallized, oriented multi-layer polymeric films of embodiments 1 to 20, comprising: a) forming i) a layer A comprising a first polyolefin composition and ii) a layer B comprising 50.0 to 99.9 wt % of a second polyolefin composition and 0.1 to 50.0 wt % of at least one conductive polymer composition, based on the weight of the layer B, the layer B having a first side and a second side, where the first side of the layer B is in surface contact with layer A; and b) metallizing second side of layer B.
   23. Embodiment 22 includes methods wherein forming layer A and layer B comprises coextruding layer A and the layer B.

### Examples

The new and useful combination of properties of the films described herein will now be further illustrated with reference to the following examples. The various properties, as determined by the test methods above, were measured with respect to a reference five layer polymeric film, each layer comprising propylene-based polymers.

### Comparative Example 1

A multi-layer polymeric film is coextruded and oriented. The film comprises a layer E comprising a 0.024 mil polypropylene layer 1 (JPP-7510) is in surface contact with a 0.138 mil layer D comprising polypropylene and about 10.0 wt % TiO₂ whitening agent (Ampacet 511094). On layer D in turn is in surface contact with a 1.576 mil polypropylene-containing core layer C, cavitated with 5 wt % PBT. The core layer C is in surface contact with a 0.138 mil layer A comprising polypropylene and about 10.0 wt % TiO₂ whitening agent (Ampacet 511094). Layer A is in surface contact with layer B comprising a high ethylene-content, propylene-ethylene copolymer having a melt flow rate of 6.8 g/10 min. ASTM D-1238, 230° C., 2.16 kg), a density of 0.895 g/cc (ASTM D-1505), and a melting point of 135° C. (DSC) (Polypropylene 8573 HB from Total Petrochemicals). The film has a surface resistivity of 15.9 log ohm/square at 22° C. and 50% relative humidity. After orientation, the uncoated untreated surface of layer B was metallized by aluminum evaporation in a bell jar. The metal/layer B adhesion strength is 360 g/in (141 g/cm).

### 5-Layer White Opaque Coex Film Structure of Comparative Example 1

| | Layer | Thickness | Composition |
|---|---|---|---|
| | B (out) | 0.024 mil | EP-8573 |
| | A | 0.138 mil | PP + 8% Ampacet-511094 (TiO2 mb) |
| | C | 1.576 mil | PP + 5% PBT |
| | D | 0.138 mil | PP + 8% Ampacet-511094 |
| | E (in) | 0.024 mil | JPP-7510 |
| poly | Total | 1.9 mil | |
| gauge | | | |

### Example 1

Example 1 is substantially repeated except that layer B comprises 85.0 wt % of the Polypropylene 8573 HB and 15.0 wt % of the conductive polymer composition PELESTAT-201. The film has a surface resistivity of 12.0 log ohm/square at 22° C. and 50% relative humidity. After orientation, the uncoated untreated surface of layer B was metallized by aluminum evaporation in a bell jar. The metal/layer B adhesion strength is 461 g/in (181 g/cm).

### Example 2

Example 1 is substantially repeated except that layer B comprises 85.0 wt % of the Polypropylene 8573 HB and 15.0 wt % of the conductive polymer composition PELESTAT-212. The film has a surface resistivity of 11.4 log ohm/square at 22° C. and 50% relative humidity. After orientation, the uncoated untreated surface of layer B was metallized by aluminum evaporation in a bell jar. The metal/layer B adhesion strength is 396 g/in (156 g/cm).

### Example 3

Example 1 is substantially repeated except that layer B comprises 85.0 wt % of the Polypropylene 8573 HB and 15.0 wt % of the conductive polymer composition PELESTAT-230. The film has a surface resistivity of 11.0 log ohm/square at 22° C. and 50% relative humidity. After orientation, the uncoated untreated surface of layer B was metallized by aluminum evaporation in a bell jar. The metal/layer B adhesion strength is 505 g/in (199 g/cm).

### Example 4

Example 1 is substantially repeated except that layer B comprises 85.0 wt % of the Polypropylene 8573 HB and 15.0 wt % of the conductive polymer composition PELESTAT-230VH. The film has a surface resistivity of 11.2 log ohm/square at 22° C. and 50% relative humidity. After orientation, the uncoated untreated surface of layer B was metallized by aluminum evaporation in a bell jar. The metal/layer B adhesion strength is 573 g/in (226 g/cm).

### Example 5

Example 1 is substantially repeated except that layer B comprises 90.0 wt % of the Polypropylene 8573 HB and 10.0 wt % of the conductive polymer composition PELESTAT-230VH. The film has a surface resistivity of log 11.6 ohm/square at 22° C. and 50% relative humidity. After orientation, the uncoated untreated surface of layer B was metallized by aluminum evaporation in a bell jar. The metal/layer B adhesion strength is 407 g/in (160 g/cm).

### Example 3

Example 1 is substantially repeated except that layer B comprises 50.0 wt % of the Polypropylene 8573 HB and 15.0 wt % of the conductive polymer composition Premix-11222. The film has a surface resistivity of 11.3 log ohm/square at 22° C. and 50% relative humidity. After orientation, the uncoated untreated surface of layer B was metallized by aluminum evaporation in a bell jar. The metal/layer B adhesion strength is 215 g/in (85.6 g/cm).

TABLE 1

| | | | Uncoated, Out | | |
|---|---|---|---|---|---|
| | | Surface | Treated, Bell Jar | Treated, Ink Draw | Untreated, Ink Draw |
| | | Resistivity | Metallization | Down (Aqualam | Down (Aqualam |
| | | Ohm/sq, 72 F, | Lako metal | Water Based Ink) | Water Based Ink) |
| Example | Outside Skin | 50% RH | adhesion, g/in | % ink pick off | % ink pick off |
| CE1 | EP 8573-HB | 15.9 | 360 | 20% | 98% |
| 1 | +15% Pelestate- | 12 | 461 | 10% | 95% |
| | 201 | | | | |
| 2 | +15% Pelestate- | 11.4 | 398 | 2% | 98% |
| | 212 | | | | |
| 3 | +15% Pelestate- | 11 | 505 | 0% | 75% |
| | 230 | | | | |
| 4 | +15% Pelestate- | 11.2 | 573 | 0% | 75% |
| | 230VH | | | | |
| 5 | +10% Pelestate- | 11.6 | 407 | 0% | 75% |
| | 230VH | | | | |
| 6 | +50% Premix | 11.3 | 215 | 0% | 75% |
| | 11222 | | | | |

All documents described herein are incorporated by reference herein, including any priority documents and/or testing procedures to the extent they are not inconsistent with this text, provided however that any priority document not named in the initially filed application or filing documents is not incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise, “comprising” relates to the terms “consisting essentially of,” “is,” and “consisting of” and anyplace “comprising” is used “consisting essentially of,” “is,” or “consisting of” may be substituted therefore.

1. A metallized, oriented multi-layer polymeric film comprising:
a) at least one layer A, comprising a first polyolefin composition; and
b) a metallized layer B having a first side in surface contact with layer A, the metallized layer B comprising:
(i) 50.0 to 99.9 wt % of a second polyolefin composition, and
(ii) 0.1 to 50.0 wt % of at least one conductive polymer composition having a volume resistivity of 1.0×10⁵ to 1.0×10¹² ohm·cm (Ω·cm), based on the weight of the layer B; and
c) a metal layer in surface contact with the metallized layer B.

2. The metallized, oriented multi-layer polymeric film of claim 1, wherein the conductive polymer composition comprises a block polymer comprising blocks of a polyolefin and blocks of a hydrophilic polymer.

3. The metallized, oriented multi-layer polymeric film of claim 1, wherein the conductive polymer composition has a number average molecular weight of 2.0×10³ g/mol to 6.0×10⁴ g/mol as determined by gel permeation chromatography.

4. The metallized, oriented multi-layer polymeric film of claim 1, wherein the conductive polymer composition comprises at least one polyether-polyolefin block copolymer.

5. The metallized, oriented multi-layer polymeric film of claim 4, wherein the conductive polymer composition comprises:
(i) 5.0 to 50.0 wt % of the at least one polyether-polyolefin block copolymer; and
(ii) 50 to 95.0 wt % of at least one propylene-based polymer; based on the combined weights of (i) and (ii).

6. The metallized, oriented multi-layer polymeric film of claim 1, wherein the conductive polymer composition comprises at least one polyetherester-amide block copolymer.

7. The metallized, oriented multi-layer polymeric film of claim 6, wherein the conductive polymer composition comprises
(i) 3.0 to 40.0 wt % of the at least one polyetherester-amide block copolymer; and
(ii) 60.0 to 97.0 wt % of at least one propylene-based polymer; based on the combined weights of (i) and (ii).

8. The metallized, oriented multi-layer polymeric film of claim 1, wherein the layer B comprises from 5.0 to 25.0 wt % of the conductive polymer composition.

9. The metallized, oriented multi-layer polymeric film of claim 1, wherein the layer B comprises from 10.0 to 20.0 wt % of the conductive polymer composition.

10. The metallized, oriented multi-layer polymeric film of claim 1, wherein layer A comprises a tie layer and a core layer, wherein the tie layer is in surface contact with the layer B.

11. The metallized, oriented multi-layer polymeric film of claim 1, wherein layer A includes a cavitating agent.

12. The metallized, oriented multi-layer polymeric film of claim 1, wherein the first polyolefin composition and the second polyolefin composition are the same or different.

13. The metallized, oriented multi-layer polymeric film of claim 1, wherein the first polyolefin composition has a comonomer content, a Mw, a MWD, a melt flow rate, or a melting point different from the comonomer content, Mw, MWD, melt flow rate, or melting point of the second polyolefin composition.

14. The metallized, oriented multi-layer polymeric film of claim 1, wherein the first polyolefin composition comprises one or more polypropylene homopolymers and/or one or more copolymers of propylene and at least one C₂ or C₄-C₂₀ α-olefin.

15. The metallized, oriented multi-layer polymeric film of claim 1, wherein the second polyolefin composition comprises one or more copolymers of propylene and at least one C₂ or C₄-C₂₀.

16. The metallized, oriented multi-layer polymeric film of claim 1, wherein metallized layer B has a surface resistivity ≦15.0 ohms/square, measured at 50% RH and 23° C.

17. The metallized, oriented multi-layer polymeric film of claim 1 having a metal adhesion strength ≧150 g/cm.

18. The metallized, oriented multi-layer polymeric film of claim 1, wherein the metal layer comprises at least one metal selected from the group consisting of aluminum, gold, silver, chromium, tin, copper and combinations thereof.

19. A multi-layer polymeric film comprising:
a) a barrier layer comprising aluminum, gold, silver, chromium, tin, copper or combinations thereof;
b) a layer B in surface contact with the barrier layer, comprising 50.0 to 99.9 wt % of an propylene-ethylene copolymer having from 75 to 99 wt % units derived from propylene and 5 to 25 wt % units derived from ethylene and 0.1 to 50.0 wt % of at least one polyether-polyolefin block copolymer, based on the weight of the layer B;
c) a first tie layer in surface contact with the layer B, the first tie layer comprising a polypropylene homopolymer or a propylene-ethylene copolymer;
d) a cavitated core layer in surface contact with the first tie layer, the core layer comprising polypropylene and 2.0 to 10.0 wt % of a cavitating agent;
e) a second tie layer in surface contact with the cavitated core layer, the second tie layer comprising a polypropylene homopolymer or a propylene-ethylene copolymer; and
f) a backside layer comprising a propylene-ethylene copolymer, a propylene-butylene copolymer or an ethylene-propylene-butylene terpolymer, wherein the backside layer is in surface contact with the second tie layer.

20. The multi-layer polymeric film of claim 19, wherein the barrier layer comprises aluminum.

21. The multi-layer polymeric film of claim 20 having a metal adhesion strength of 400 to 600 g/in.

22. A method of making metallized, oriented multi-layer polymeric film, comprising:
a) forming i) a layer A comprising a first polyolefin composition and ii) a layer B comprising 50.0 to 99.9 wt % of a second polyolefin composition and 0.1 to 50.0 wt % of at least one conductive polymer composition, based on the weight of the layer B, the layer B having a first side and a second side, where the first side of the layer B is in surface contact with layer A; and
b) metallizing second side of layer B.

23. The method of claim 22, wherein forming layer A and layer B comprises coextruding layer A and the layer B.
